(19) United States
(12) Patent Application Publication
(10) Pub. No.: US 2021/0028498 A1
(43) Pub. Date: Jan. 28, 2021

(54) BATTERY CELL AND BATTERY

(71) Applicant: NINGDE AMPEREX TECHNOLOGY LIMITED, Ningde (CN)

(72) Inventors: Mingliang MO, Ningde (CN); Wei Shu, Ningde (CN); Jie Yang, Ningde (CN)

(21) Appl. No.: 17/068,686

(22) Filed: Oct. 12, 2020

Related U.S. Application Data
(63) Continuation of application No. PCT/CN2018/082716, filed on Apr. 11, 2018.

(51) Int. Cl. H01M 10/0587; H01M 10/0525; H01M 4/78

(52) U.S. Cl. CPC H01M 10/0587; H01M 2/0275; H01M 4/78; H01M 10/0525

(57) ABSTRACT

A battery cell, including a first electrode plate, a second electrode plate, and a separator located between the first electrode plate and the second electrode plate. The first electrode plate and the second electrode plate include a first current collector and a second current collector respectively, the first current collector includes a first uncoated region, and the second current collector includes a second uncoated region facing the first uncoated region. In a width direction of the battery cell, the first uncoated region and the second uncoated region are both located on lateral parts of the battery cell. The battery cell and a battery including the battery cell are capable of improving abuse performance of the battery cell and avoiding energy density loss.

### CROSS-REFERENCE TO RELATED APPLICATIONS

This application is the national phase entry of International Application No. PCT/CN2018/082716 filed on Apr. 11, 2018, the contents of which are incorporated by reference herein.

### TECHNICAL FIELD

This application relates to the field of batteries, and more specifically, to a battery cell and a battery with the battery cell.

### BACKGROUND

With further development of commercial batteries, lithium-ion batteries are pursuing higher energy densities. However, a battery cell of a high energy density is at safety risks, and can hardly pass tests of abuse performance such as a nail penetration test and a crush test.

Currently, a common means of improving abuse performance is to form a structure of opposite uncoated regions defined by an uncoated cathode current collector facing an uncoated anode current collector. However, this winding method has a disadvantage of sacrificing a large amount of energy density. In other structures, the structure of opposite uncoated regions is generally formed on a front surface and a rear surface of a battery cell, thereby also sacrificing a large amount of energy density. In view of defects of the prior art, this application is hereby put forward.

### SUMMARY

In view of problems existent in the prior art, this application aims to provide a battery cell and a battery that are capable of improving abuse performance of the battery cell and avoiding energy density loss.

According to an embodiment of this application, a battery cell is provided, including a first electrode plate, a second electrode plate, and a separator located between the first electrode plate and the second electrode plate. The first electrode plate and the second electrode plate include a first current collector and a second current collector respectively, the first current collector includes a first uncoated region, and the second current collector includes a second uncoated region facing the first uncoated region. In a width direction of the battery cell, the first uncoated region and the second uncoated region are both located on lateral parts of the battery cell.

According to an embodiment of this application, the battery cell includes a first lateral part and a second lateral part facing each other in the width direction, the first uncoated region includes two parts located in the first lateral part and the second lateral part respectively, and the second uncoated region includes two parts located in the first lateral part and the second lateral part respectively.

According to an embodiment of this application, the first current collector forms an outermost layer of the battery cell; and, in second lateral part, the second current collector further includes a third uncoated region located on a back side of the second uncoated region.

According to an embodiment of this application, the first current collector forms an outermost layer of the battery cell; and, in the second lateral part, the first current collector further includes a second outermost layer located inside the outermost layer, and the first uncoated region is formed on an inner surface of the second outermost layer.

According to an embodiment of this application, in the first lateral part and the second lateral part, the first uncoated region is formed on a surface of any layer of the first current collector, and the second uncoated region is formed on a surface of any layer of the second current collector.

According to an embodiment of this application, in the first lateral part and the second lateral part, a first uncoated region is constructed on both surfaces of the first current collector, and a second uncoated region is constructed on both surfaces of the second current collector.

According to an embodiment of this application, the battery cell includes a first lateral part and a second lateral part facing each other along a width direction. In the first lateral part, the second current collector further includes a third uncoated region located on a back side of the second uncoated region, and the first current collector further includes a fourth uncoated region facing the third uncoated region.

According to an embodiment of this application, green adhesive is also disposed between the first uncoated region and the separator.

According to an embodiment of this application, the first current collector is a cathode current collector, and the second current collector is an anode current collector.

According to an embodiment of this application, a battery is further provided. The battery includes a packaging bag and the aforementioned battery cell sealed in the packaging bag.

Beneficial technical effects of this application are:

In the battery cell and the battery provided in this application, the first uncoated region of the first current collector and the second uncoated region of the second current collector face each other, thereby forming opposite uncoated regions between the first uncoated region and the second uncoated region. When the battery cell is abused, the opposite uncoated regions may be short-circuited first, so as to avoid safety problems such as burning or explosion. Furthermore, the opposite uncoated regions formed are located on the lateral parts of the battery cell along the width direction of the battery cell. Compared with the prior art in which the structure of opposite uncoated regions is formed on a front surface and a rear surface of the battery cell, this application provides an opposite uncoated region without affecting a thickness of the battery cell, and therefore, effectively increases an energy density.

### DESCRIPTION OF DRAWINGS

FIG. 1 is a sectional view of an embodiment of a battery cell according to this application;

FIG. 2 is a sectional view of another embodiment of a battery cell according to this application;

FIG. 3 is a sectional view of another embodiment of a battery cell according to this application;

FIG. 4 is a sectional view of still another embodiment of a battery cell according to this application; and

FIG. 5 is a sectional view of yet another embodiment of a battery cell according to this application.

### DETAILED DESCRIPTION

The following describes embodiments of this application with reference to accompanying drawings. Understandably, corresponding exemplary embodiments in the following specification and accompanying drawings may be combined with each other to form other embodiments that are not described below; and some of the parts thereof may be omitted in different embodiments. In other words, the following description does not constitute any limitation on this application.

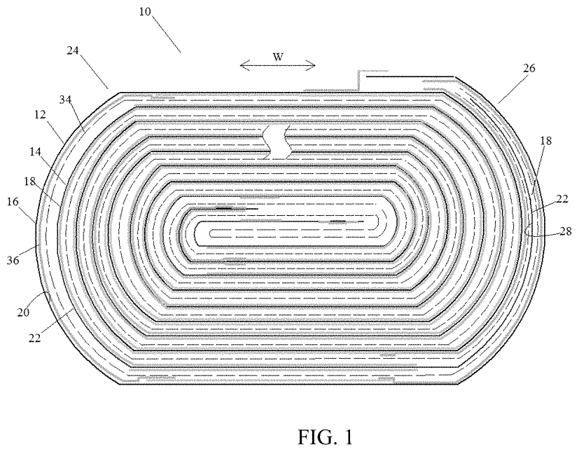

As shown in FIG. 1, according to an embodiment of this application, a battery cell 10 is provided. In summary, the battery cell 10 includes a first electrode plate 12 and a second electrode plate 14. The first electrode plate 12 and the second electrode plate 14 include a first current collector 16 and a second current collector 18 respectively. The first current collector 16 includes a first uncoated region 20. Correspondingly, the second current collector 18 includes a second uncoated region 22 facing the first uncoated region 20. In other words, the first uncoated region 20 of the first current collector 16 and the second uncoated region 22 of the second current collector 18 face each other, and neither cathode active substance nor anode active substance exists between the first uncoated region and the second uncoated region, thereby forming the “opposite uncoated regions”. When the battery cell is abused, the opposite uncoated regions may be short-circuited first, so as to avoid safety problems such as burning or explosion.

Further, as shown in FIG. 1, along a width direction W of the battery cell 10, the first uncoated region 20 and the second uncoated region 22 are both located on lateral parts of the battery cell 10 (for example, on a first lateral part 24 and a second lateral part 26 to be described below). The opposite uncoated region formed is located on the lateral parts of the battery cell along the width direction W of the battery cell. Therefore, compared with the prior art in which the opposite uncoated region is formed on a front surface and a rear surface of the battery cell, this application provides an opposite uncoated region without affecting a thickness of the battery cell, and therefore, effectively increases an energy density.

Specifically, as shown in FIG. 1, in an embodiment, the battery cell 10 may include a first lateral part 24 and a second lateral part 26 facing each other along the width direction W. The first lateral part 24 and the second lateral part 26 form two transverse sides of the battery cell 10. The first uncoated region 20 may include two parts located in the first lateral part 24 and the second lateral part 26 respectively, and the second uncoated region 22 may include two parts located in the first lateral part 24 and the second lateral part 26 respectively. In other words, the opposite uncoated region may be formed in both transverse lateral parts of the battery cell 10, thereby improving safety performance of the battery cell.

The following describes optional embodiments of this application with reference to accompanying drawings. Understandably, the following embodiments described with reference to the accompanying drawings are only illustrative. This application is not limited to one or some of the specific implementations. As required, the following embodiments may be combined with each other to form an embodiment not shown in the drawings.

In addition, it needs to be pointed out that the first current collector 16 can be a cathode current collector, and second current collector 18 can be an anode current collector. Correspondingly, the first electrode plate 12 can be a cathode electrode plate, and the second electrode plate 14 can be an anode electrode plate. Understandably, “cathode” and “anode” described above may be interchanged, and this application is not limited thereto.

In the following embodiments, the embodiments are described by using an example in which the first electrode plate 12 is a cathode electrode plate and the second electrode plate 14 is an anode electrode plate.

In the embodiment shown in FIG. 1, the first current collector 16 of the battery cell 10 may form an outermost layer of the battery cell 10. In the second lateral part 26 of the battery cell 10, the second current collector 18 may further include a third uncoated region 28 located on a back side of the second uncoated region 22. In other words, in this embodiment, neither surface of the second current collector 18 located in the second lateral part 26 is coated with any active substance, as shown in FIG. 1.

In this embodiment, the first current collector 16 forms the outermost layer of the battery cell 10, Therefore, the formed opposite uncoated region is surrounded inside the first current collector 16 that is the outermost layer. In this way, the opposite uncoated region is not visible from outside the battery cell 10. Therefore, this structure may also be referred to as “hidden opposite uncoated region”.

Specifically, in the embodiment shown in FIG. 1, a symmetric structure of opposite uncoated regions at lateral sides of the outermost layer is adopted. In the first lateral part 24, the structure corresponds to a single-sided anode electrode plate and a single-sided cathode electrode plate. In the second lateral part 26, there is an outer structure of opposite uncoated regions formed by extending an end of the anode current collector 18. The extended anode current collector 18 forms two opposite uncoated regions with a single-sided cathode current collector at the second outermost layer and a cathode current collector at the outermost layer thereof, respectively. This effectively improves safety performance of the battery cell.

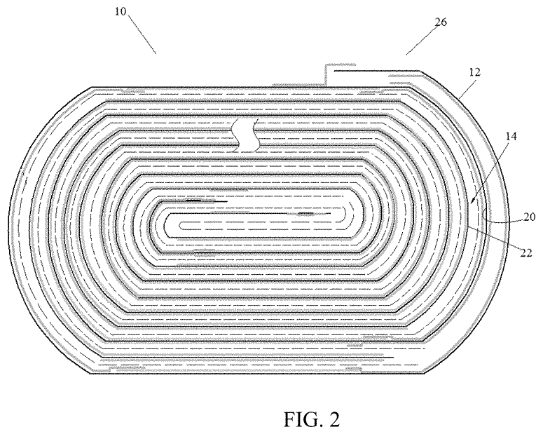

In the embodiment shown in FIG. 2, the first current collector 16 forms the outermost layer of the battery cell 10. In the second lateral part 26, the first current collector 16 further includes the second outermost layer located inside the outermost layer. The first uncoated region 20 is formed on an inner surface of the second outermost layer. Specifically, in the embodiment shown in FIG. 2, the structure in the first lateral part 24 is similar to the embodiment shown in FIG. 1. In the second lateral part 26, the uncoated region 20 is formed on the second outermost layer inside the first current collector 16 that is the outermost layer, so that a hidden structure of opposite uncoated regions is also formed in the second lateral part 26.

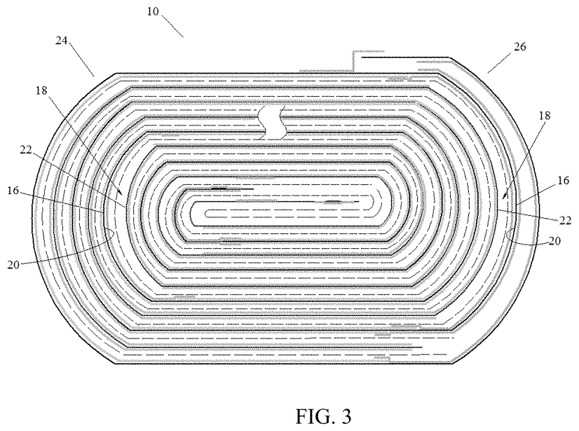

Referring to the embodiment shown in FIG. 3, in the first lateral part 24 and the second lateral part 26, the first uncoated region 20 is formed on a surface of any layer of the first current collector 16, and the second uncoated region 22 is formed on a surface of any layer of the second current collector 18. In other words, for example, in this embodiment, an asymmetric structure of a hidden opposite uncoated region at lateral sides may be adopted. In the first lateral part 24, a hidden opposite uncoated region may exist on any layer from an innermost layer to the outermost layer; and in the second lateral part 26, a hidden opposite uncoated region may exist on any layer from the innermost layer to the second outermost layer.

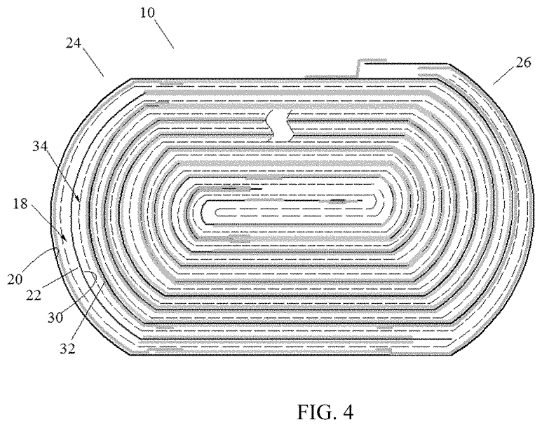

Still referring to the accompanying drawings, in the embodiment shown in FIG. 4, in the first lateral part 24, the second current collector 18 further includes a third uncoated region 30 located on a back side of the second uncoated region 22, and the first current collector 16 further includes a fourth uncoated region 32 facing the third uncoated region 30. In other words, in this embodiment, a double structure of opposite uncoated regions at a single lateral side may be formed only in the first lateral part 24. Understandably, in an optional embodiment of this application, a double structure of opposite uncoated regions at a single lateral side may also be formed only in the second lateral part 26, depending on specific use conditions. This application is not limited thereto.

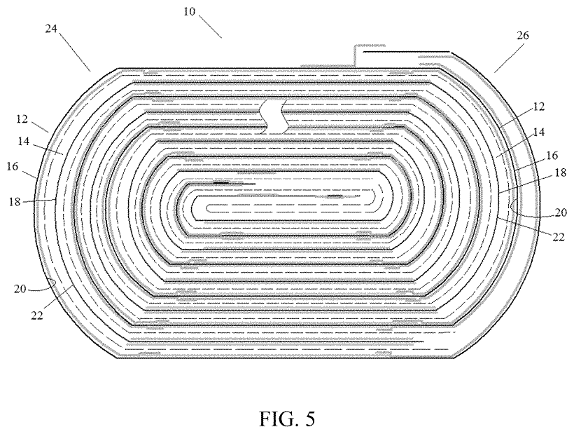

Further, as shown in FIG. 5, in another embodiment of this application, in the first lateral part 24 and the second lateral part 26, the first uncoated region 20 may be constructed on both surfaces of the first current collector 16, and the second uncoated region 22 may be constructed on both surfaces of the second current collector 18. In other words, in this embodiment, a multiple structure of opposite uncoated regions at lateral sides is adopted, and all layers at both lateral sides of the battery cell 10 are opposite uncoated regions, thereby improving the safety performance of the battery cell.

In addition, in an optional embodiment of this application, the battery cell 10 provided in this application further includes a separator 34 located between the first electrode plate 12 and the second electrode plate 14, and green adhesive 36 may be further disposed between the first uncoated region 20 and the separator 34.

In addition, this application further provides a battery. The battery includes a packaging bag and the battery cell 10 sealed in the packaging bag. Because the battery cell 10 is disposed in the battery, the battery also has all the advantages described above.

In conclusion, in the battery cell and the battery provided in this application, an opposite uncoated region is formed on one lateral side of the battery cell along the width direction W of the battery cell, and an opposite uncoated region may be formed on the other lateral side of the battery cell along the width direction W of the battery cell. Therefore, the opposite uncoated regions are formed on both lateral sides of the battery cell in this application, thereby improving the safety performance of the battery cell. The formation of the opposite uncoated regions on both lateral sides of the battery cell does not affect the thickness of the battery cell, and the formation of the hidden opposite uncoated region decreases a width of the battery cell rather than increasing the width of the battery cell. In addition, the opposite uncoated regions at lateral sides of the battery cell in this application exist only on two lateral sides of the battery cell, and a length of the opposite uncoated region is relatively small, thereby effectively increasing the energy density compared with the structure in which the opposite uncoated region is formed by the outermost layer of the battery cell with a single surface coated or neither surface coated. Compared with the structure in which the opposite uncoated region exists at a single lateral side, this application adds, at an opposite side, a structure of a hidden opposite uncoated region to better ensure abuse performance and achieve a trade-off between the energy density and the safety performance. When the battery cell is abused, the opposite uncoated region may be short-circuited first, so as to avoid safety problems such as burning or explosion.

The foregoing descriptions are merely exemplary embodiments of this application, but are not intended to limit this application. A person skilled in the art understands that this application may have various modifications and variations. Any modification, equivalent replacement, improvement, and the like made without departing from the spirit and principles of this application shall fall within the protection scope of this application.

What is claimed is:

1. A battery cell, comprising:
a first electrode plate and a second electrode plate, wherein the first electrode plate and the second electrode plate comprise a first current collector and a second current collector respectively, the first current collector comprises a first uncoated region, and the second current collector comprises a second uncoated region facing the first uncoated region; and
along a width direction of the battery cell, the first uncoated region and the second uncoated region are both located on a lateral part of the battery cell.

2. The battery cell according to claim 1, wherein along the width direction, the lateral part comprises a first lateral part and a second lateral part spaced apart from each other, the first lateral part and the second lateral part comprise the first uncoated region respectively, and the first lateral part and the second lateral part comprise the second uncoated region respectively.

3. The battery cell according to claim 2, wherein the first current collector forms an outermost layer of the battery cell; and, in the second lateral part, the second current collector further comprises a third uncoated region located on a back side of the second uncoated region.

4. The battery cell according to claim 2, wherein the first current collector forms an outermost layer of the battery cell; and, in the second lateral part, the first current collector further comprises a second outermost layer, and the first uncoated region is formed on an inner surface of the second outermost layer.

5. The battery cell according to claim 2, wherein in the first lateral part and the second lateral part, the first uncoated region is formed on a surface of any layer of the first current collector, and the second uncoated region is formed on a surface of any layer of the second current collector.

6. The battery cell according to claim 1, wherein the battery cell comprises a first lateral part and a second lateral part spaced apart from each other along the width direction; in the first lateral part, the second current collector further comprises a third uncoated region located on a back side of the second uncoated region, and in the first lateral part, the first current collector further comprises a fourth uncoated region facing the third uncoated region.

7. The battery cell according to claim 1, wherein the second current collector further comprises a tail section, and the tail section comprises a straight section extending along the width direction, and an active substance layer is disposed on both surfaces of the straight section.

8. The battery cell according to claim 1, wherein a separator is disposed between the first current collector and the second current collector, and an insulation tape is disposed between the first uncoated region and the separator.

9. The battery cell according to claim 1, wherein the first current collector is a cathode current collector, and the second current collector is an anode current collector.

10. The battery cell according to claim 1, wherein the first uncoated region and the second uncoated region are located on the same lateral part of the battery cell, the first uncoated region faces the second uncoated part.

11. A battery, wherein the battery comprises a battery cell and a packaging bag accommodating the battery cell;
wherein the battery cell comprises a first electrode plate and a second electrode plate, wherein the first electrode plate and the second electrode plate comprise a first current collector and a second current collector respectively, the first current collector comprises a first uncoated region, and the second current collector comprises a second uncoated region facing the first uncoated region; and
along a width direction of the battery cell, the first uncoated region and the second uncoated region are both located on a lateral part of the battery cell.

12. The battery according to claim 11, wherein along the width direction, the lateral part comprises a first lateral part and a second lateral part spaced apart from each other, the first lateral part and the second lateral part comprise the first uncoated region respectively, and the first lateral part and the second lateral part comprise the second uncoated region respectively.

13. The battery according to claim 12, wherein the first current collector forms an outermost layer of the battery cell; and, in the second lateral part, the second current collector further comprises a third uncoated region located on a back side of the second uncoated region.

14. The battery according to claim 12, wherein the first current collector forms an outermost layer of the battery cell; and, in the second lateral part, the first current collector further comprises a second outermost layer, and the first uncoated region is formed on an inner surface of the second outermost layer.

15. The battery according to claim 12, wherein in the first lateral part and the second lateral part, the first uncoated region is formed on a surface of any layer of the first current collector, and the second uncoated region is formed on a surface of any layer of the second current collector.

16. The battery according to claim 11, wherein the battery cell comprises a first lateral part and a second lateral part spaced apart from each other along the width direction; in the first lateral part, the second current collector further comprises a third uncoated region located on a back side of the second uncoated region, and in the first lateral part, the first current collector further comprises a fourth uncoated region facing the third uncoated region.

17. The battery according to claim 11, wherein the second current collector further comprises a tail section, and the tail section comprises a straight section extending along the width direction, and an active substance layer is disposed on both surfaces of the straight section.

18. The battery according to claim 11, wherein a separator is disposed between the first current collector and the second current collector, and an insulation tape is disposed between the first uncoated region and the separator.

19. The battery according to claim 11, wherein the first current collector is a cathode current collector, and the second current collector is an anode current collector.

20. The battery according to claim 11, wherein the first uncoated region and the second uncoated region are located on the same lateral part of the battery cell, the first uncoated region faces the second uncoated part.
